(19) United States
(12) Patent Application Publication
(10) Pub. No.: US 2008/0110648 A1
(43) Pub. Date: May 15, 2008

(54) Machine and implement positioning method therefor

(76) Inventors: Brian Howson, Peoria, IL (US); Glen A. Spindel, Divernon, IL (US); Kevin L. Martin, Washburn, IL (US)

Correspondence Address: CATERPILLAR c/o LIELL & MCNEIL ATTORNEYS PC, P.O. BOX 2417, 511 SOUTH MADISON STREET, BLOOMINGTON, IN, 47402-2417, US

(21) Appl. No.: 11/588,787

(22) Filed: Oct. 27, 2006

(51) Int. Cl. A01B 51/00

(52) U.S. Cl. 172/272

(57) ABSTRACT

A machine includes a frame and a coupler assembly suspended below the frame, the coupler assembly configured for sideshift movement and having an implement mounting element for engaging with a mating feature on an implement. An implement grabber mounted to the coupler assembly is configured to grab an implement and move the implement via sideshift movement of the coupler assembly from a position lateral of the frame to a mounting position at which the mounting element of the coupler assembly can engage with the mating feature of the implement. A method of implement positioning for a machine includes grabbing the implement with a implement grabber mounted on a coupler assembly and moving the implement with the coupler assembly. The method also includes disengaging the implement from the implement grabber and actuating a mounting element of the coupler assembly to engage or disengage with the mating feature of the implement. The method and machine are amenable to mounting long objects to a motor grader, which are unsuitable for pick up via conventional means.

### TECHNICAL FIELD

The present disclosure relates generally to machines and positioning and coupling strategies for implements used with a machine, and relates more particularly to an apparatus and method wherein an implement coupler assembly is movable laterally of a machine to retrieve and dispose of implements when conventional retrieval and/or disposition is not practicable.

### BACKGROUND

Many modern machines used in earthworking, construction, mining, agriculture and similar industries utilize specialized implements for performing various tasks. Certain machines have long been designed to couple with and utilize a variety of implements, the implements being selected based upon the particular work performed by the machine. While the desirability of flexibility in implement-machine compatibility has long been recognized, certain machines are less amenable than others to use with different classes of implements, often because the overall machine design has traditionally been directed to relatively narrow applications. Motor graders and the like represent one group of machines which, while performing very well in certain tasks such as road grading and snow removal, have been limited in their use in nontraditional applications. As a result, motor graders often sit idle when their owners and operators would like to be able to use them. The limitation on motor graders to work in only certain applications relates to a certain extent to the overall machine design, as well as the means by which they are traditionally manufactured.

Motor graders typically include a grader blade suspended below the machine's frame, and mounted in the middle of the machine between the front and back wheels. Due to this design, a motor grader cannot swap implements as readily as certain other machines, such as loaders, which typically have front mounted implements. If an implement is to be mounted to a motor grader, the machine can in some instances be driven around the implement such that the implement coupling mechanism is positioned close enough to the implement for mounting. This approach, however, works less well, if at all, with implements that are relatively long, as the machine often cannot readily turn tightly enough due to its long frame to position the coupling mechanism close enough to the implement for easy mounting. Motor graders also often have factory installed blades, which tend to be relatively labor intensive to uncouple and replace. Despite these challenges to implement mounting, there remain strong incentives to increase the utilization of motor graders.

One means by which engineers have attempted to broaden the range of motor grader use has been via supplementary attachments which couple directly to a motor grader blade. U.S. Pat. No. 5,695,013 to Waldron is one such device, and provides a dirt distribution device that attaches to an earth moving blade of a grader. In Waldron's design, the supplementary device is mounted to an adjustable support arm that mounts the device to an outboard end of the blade. While Waldron's strategy may improve the performance of a motor grader in certain types of operations, the system falls short of adapting a motor grader for truly new uses, and requires the supplementary device to be coupled to and work in concert with the existing grader blade.

The present disclosure is directed to one or more of the problems or shortcomings set forth above.

### SUMMARY OF THE INVENTION

In one aspect, the present disclosure provides a machine having a frame with a front set of ground engaging elements and at least one back set of ground engaging elements, and defining a longitudinal axis. A coupler assembly is suspended below the frame and disposed between the front set of ground engaging elements and the at least one back set of ground engaging elements. The coupler assembly is configured for movement transverse to the axis and has an implement mounting element for engaging with a mating feature of an implement. The machine further includes an implement grabber mounted to the coupler assembly and configured for grabbing an implement and moving the implement via movement of the coupler assembly to a mounting location relative to the frame at which the mounting element of the coupler assembly can engage with the mating feature of the implement.

In another aspect, the present disclosure provides an implement positioning method for a machine. The method includes grabbing an implement with an implement grabber mounted on a coupler assembly of the machine, the coupler assembly being suspended below a frame of the machine and disposed between front and back ground engaging elements of the machine. The method further includes moving the implement with the coupler assembly transverse to a longitudinal axis of the frame and toward one of a disposal location and a mounting location relative to the frame, after grabbing the implement with the implement grabber. Still further, the method includes disengaging the implement from the implement grabber, and actuating a mounting element of the coupler assembly to engage or disengage with a mating feature of the implement.

In still another aspect, the present disclosure provides an implement assembly for a machine. The implement assembly includes a coupler assembly having a front side, a back side opposite the front side and a width dimension. The coupler assembly is configured for movement relative to a frame of the machine in directions aligned with the width dimension, the implement assembly further including a mounting element configured to engage with a mating feature of an implement for mounting an implement at the front side of the coupler assembly. An implement grabber is mounted to the coupler assembly and configured for grabbing an implement and moving the implement with the coupler assembly to a mounting location at which the mounting element of the coupler assembly can engage with the mating feature of the implement.

### BRIEF DESCRIPTION OF THE DRAWINGS

FIG. 1 is a side diagrammatic view of a machine according to one embodiment;

FIG. 2 is a top schematic view of a machine according to one embodiment;

FIG. 3 is a pictorial view of a coupler assembly and implement according to one embodiment;

FIG. 4 is a partial pictorial view of a coupler assembly and implement as in FIG. 3;

FIG. 5 is a partial view of the coupler assembly and implement of FIGS. 3 and 4 shown in a different configuration; and

FIG. 6 is a pictorial view showing an implement mounted to a coupler assembly according to one embodiment.

### DETAILED DESCRIPTION

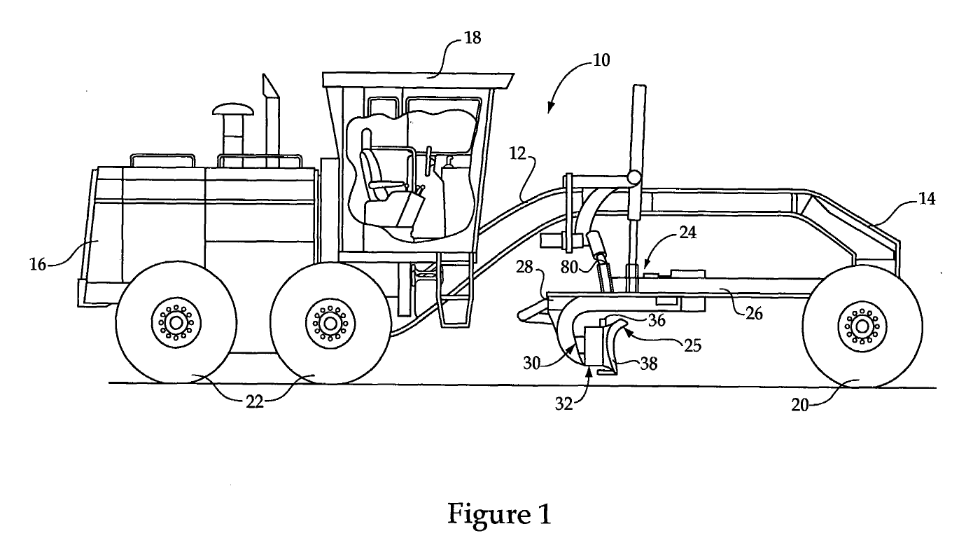

Referring to FIG. 1, there is shown a machine 10 having a frame 12 with a front frame unit 14 and a back frame unit 16. Machine 10 is shown in the context of a motor grader machine wherein front and back frame units 14 and 16 are configured to articulate relative to one another, however, the present disclosure is not thereby limited and non-articulated machines are contemplated herein. Machine 10 is also illustrated as having a front set of ground engaging elements 20 and at least one back set of ground engaging elements 22, for example two back sets of ground engaging elements. In other embodiments, a greater or lesser number of sets of ground engaging elements, wheels or tracks for example, might be used. Machine 10 is configured via an implement assembly 25 to retrieve and dispose of implements via sideshift movement of a coupler assembly 32, as further described herein.

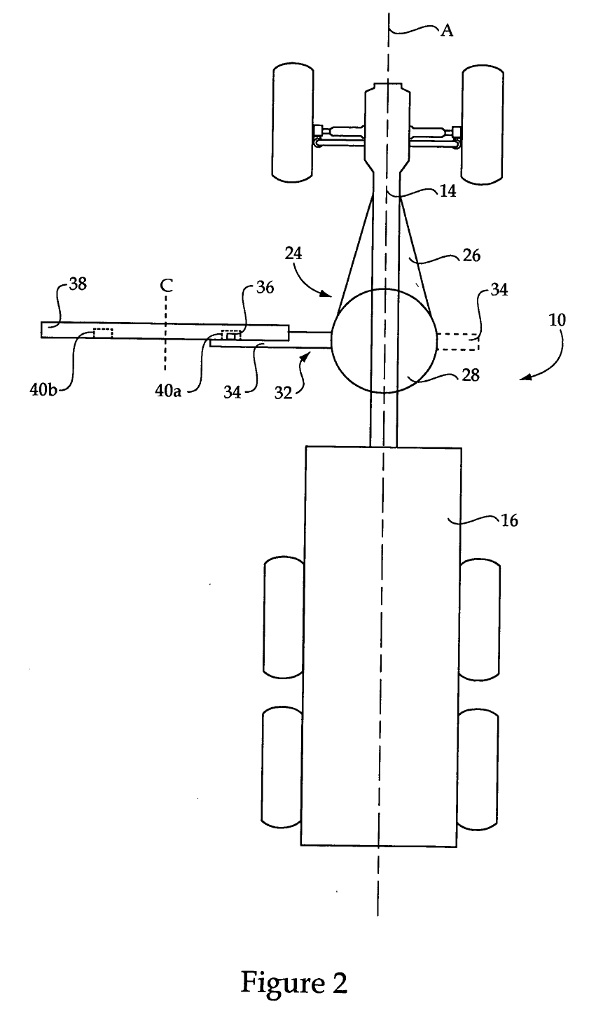

Referring also to FIG. 2, coupler assembly 32 may include a coupler body 34, and may be suspended below frame 12 and disposed between front and back sets of ground engaging elements 20 and 22. Coupler assembly 32 may be configured for sideshift movement relative to a longitudinal axis A of machine 10 within a retention assembly 30 of implement assembly 25, retention assembly 30 in turn being coupled with or part of a drawbar and circle assembly 24 that includes a drawbar 26 and circle 28. Coupler assembly 32 may further include an implement grabber 36 configured for grabbing an implement 38 for retrieving and disposing of the implement via sideshift movement of coupler assembly 32. In particular, coupler assembly 32 may be movable in directions transverse to axis A to grab an implement positioned laterally of machine 10 with grabber 36, for example at a disposal location, and move the implement via sideshift movement of coupler assembly 32 to a mounting location at which the implement can be mounted to coupler assembly 32. Coupler assembly 32 may also be vertically movable relative to frame 12, enabling elevating of implement 38 to avoid dragging it across the ground when grabbed with grabber 36 and moved via coupler assembly 32.

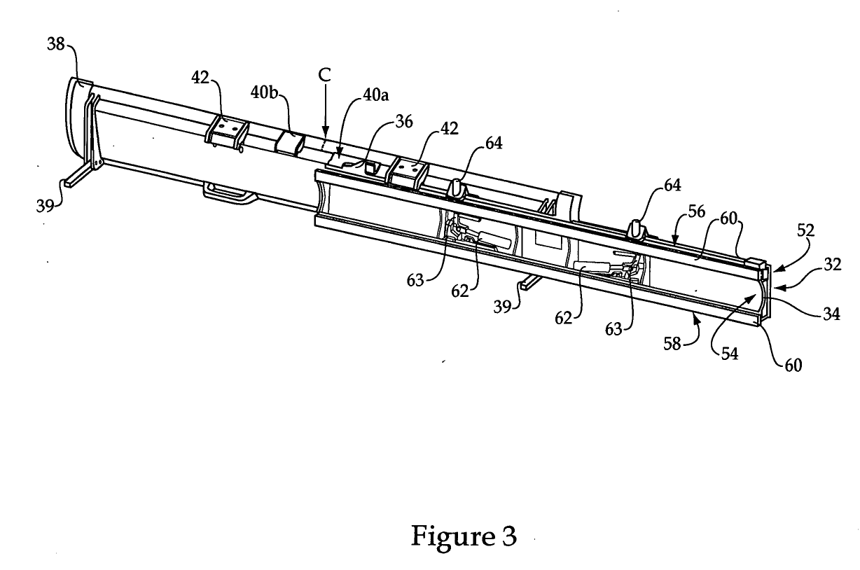

Referring also to FIG. 3, coupler body 34 of coupler assembly 32 may include an upper edge 56, a lower edge 58, a front side 52 and a back side 54, each of upper and lower edges 56 and 58 extending in parallel with a width dimension of coupler body 34. Coupler body 34 may also be equipped with rails 60 to facilitate sideshift movement relative to frame 12, transverse to axis A, and within retention assembly 30. Coupler assembly 32 may further be configured for mounting an implement such as implement 38 to front side 52, for example, via a movable mounting element 64 configured to engage with a mating feature 42 of implement 38. In one embodiment, the movable mounting element 64 may consist of movable pins 63 configured to extend from upper edge 56 and retract into body 34 to alternately engage with and disengage with mating feature 42, which may include two mating feature elements into which pins 63 can extend. Actuators 62 may be provided, such as hydraulic actuators, for actuating pins 63. In one embodiment, machine 10 may include an implement coupler of the type taught in copending and commonly owned U.S. patent application Ser. No. 11/443,066, now U.S. Pat. No. ______.

Also shown in FIG. 3 is implement grabber 36, comprising at least one hooking element 36, extending upwardly from upper edge 56. In the embodiment shown in FIG. 3, grabber 36 is engaged with a bracket 40a, separate from mating feature 42, and configured to receive grabber 36 to enable grabbing of implement 38 when disposed laterally of machine 10 relative to axis A and/or frame 12. A second bracket 40b, disposed on implement 38 and also separate from feature 42, may also be provided, and is also configured to engage with grabber 36, as further described herein. Implement 38 may also include one or more support extensions 39 which are configured to support implement 38 in a more or less upright orientation, approximately as shown in FIG. 3, enabling relatively easy grabbing of implement 38 and movement to a mounting location relative to axis A and/or frame 12 whereat mounting element 64 can engage with mating feature 42. It will further be noted from FIG. 3 that brackets 40a and 40b are disposed on opposite sides of a centerline C of implement 38, and are positioned between the elements of mating feature 42, for reasons which will be apparent from the following description.

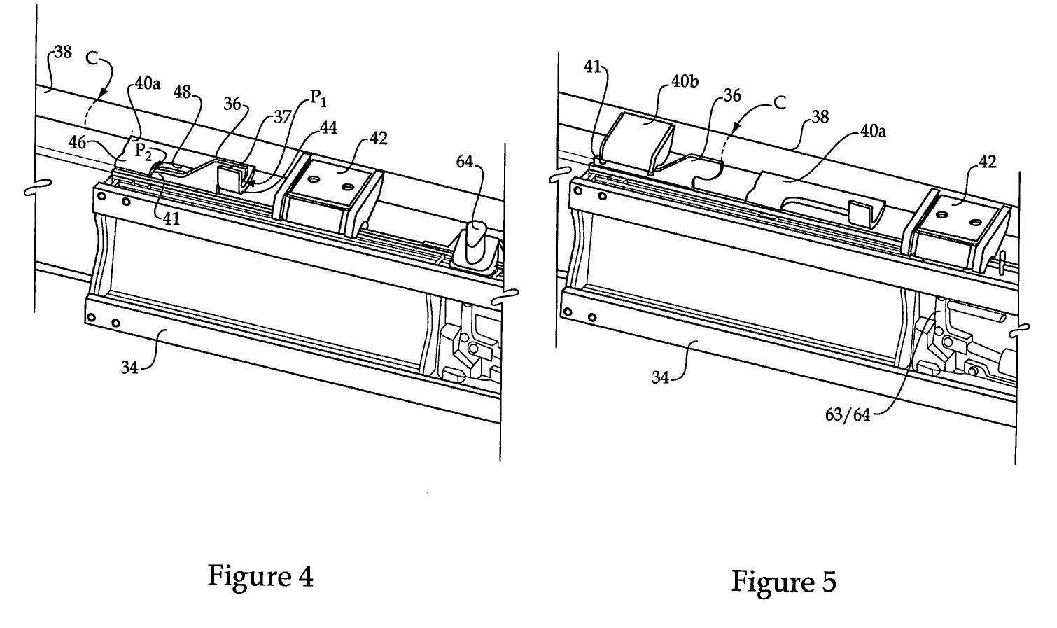

Referring also to FIG. 4, showing a close-up view of certain of the features of coupler assembly 32 and implement 38, grabber 36 may be received in a slot 48 of bracket 40a, slot 48 extending between and being defined by a first curved portion 44 and a second curved portion 46 of bracket 40a. In one embodiment, grabber 36 may be inserted into slot 48 from below, then adjusted via sideshift movement of coupler assembly 32 such that a hook portion 37 of grabber 36 engages at a first reaction point P₁ with curved portion 44 of bracket 40a. A flange portion 41 of grabber 36 can at the same time engage with the other curved portion 46 of bracket 40a at a second reaction point P₂. It will be recalled that bracket 40a may be disposed on one side of centerline C of implement 38. In one embodiment, coupler assembly 32 will be used to elevate implement 38 off of the ground when grabber 36 is used to retrieve or dispose of implement 38. Because grabber 36 will typically initially engage implement 38 via a single bracket 40a, dual reaction points will inhibit implement 38 tilting. In other words, to provide a solid pick-up of implement 38 for elevating it without tilting, interaction between grabber 36 and bracket 40a at two locations is desired to react the tilting forces on coupler assembly 32.

To this end, during a typical pick-up and retrieval sequence, further described herein, when coupler assembly 32 is used to elevate implement 38, simultaneous interaction between grabber 36 and bracket 40a at the two illustrated reaction points P₁ and P₂, will keep implement 38 from tilting. Initial grabbing of implement 38 will typically be followed by moving implement 38 a first distance in a direction transverse to axis A. Where implement 38 is retrieved from a location lateral of frame 12 for mounting, after grabbing implement 38 at the location on the implement 38 shown in FIGS. 3 and 4, i.e. via bracket 40a, implement 38 will typically be moved via sideshifting coupler assembly 32 toward axis A. Prior to initiating a retrieval sequence, a second implement, no longer appropriate for the type of work, worn, etc. may be decoupled from coupler assembly 32.

Referring now also to FIG. 5, after moving implement 38 a first distance, grabber 36 may be used to move implement 38 a second distance via grabbing implement 38 at a different location, and in a different manner. In particular, after engaging grabber 36 with bracket 40a, implement 38 may be lowered to the ground, grabber 36 disengaged from slot 48, and coupler assembly 32 extended and raised such that grabber 36, for instance flange portion 41, engages with second bracket 40b, and mounting element 64 engages with part of mating feature 52, for example via engaging of one of pins 62 therewith. It will be noted that in the FIG. 5 illustration, grabber 36 engages with bracket 40b on one side of centerline C of implement 38, whereas the rightmost part of mating feature 42 and mounting element 64 are engaged on an opposite side of centerline C. In the configuration shown in FIG. 5, since implement 38 is being picked up at two locations on opposite sides of its center of gravity, implement 38 will have a reduced or zero tendency to tilt as compared with the configuration shown in FIG. 4.

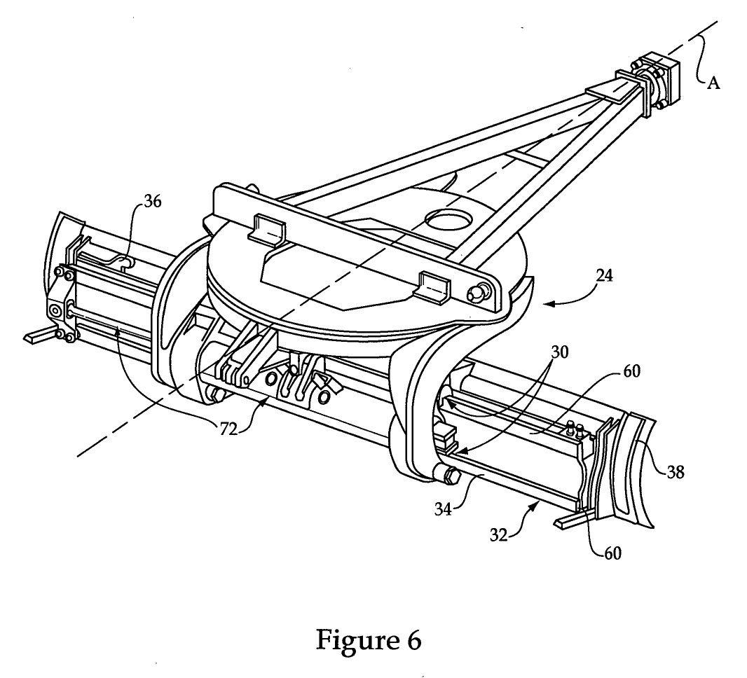

Referring to FIG. 6, once implement 38 has been moved via sideshift movement of coupler assembly 32 to a position at which coupler assembly 32 can be adjusted to properly align the components of mounting element 64 with the components of mating feature 42, actuators 63 may be actuated to urge pins 63 into brackets 42. FIG. 6 illustrates implement 38 and coupler assembly 32 in a mounted configuration at which implement 38 is ready for use with machine 10. Also shown in FIG. 6 is a hydraulic actuator 72 configured for moving coupler assembly 32 in sideshift directions transverse to axis A, and retention assembly 30 configured to support coupler assembly 32 for sideshifting via rails 60.

### INDUSTRIAL APPLICABILITY

Referring to the drawing Figures generally, and in particular to FIG. 2, when it is desirable to retrieve an implement such as implement 38 for mounting on coupler assembly 32 and use, machine 10 may be driven to a position at which implement 38 may be reached with grabber 36. Those skilled in the art will appreciate that coupler assembly 32 will typically be highly maneuverable, and can be moved up and down in a direction perpendicular axis A, moved via sideshift movement transverse to axis A, tilted, swung and rotated. Thus, there will generally be a degree of flexibility in positioning machine 10 for retrieving implement 38. Further, while implement 38 may comprise one of numerous types of grader blades, it should be appreciated that a variety of other implement types such as mowers, angled brooms, cold planers, etc. might be used. The flexibility in implement positioning for retrieval and disposal offered by the present disclosure will enable a wide variety of implement types to be readily used, in contrast to earlier designs having factory installed blades and designs wherein a supplemental implement was mounted to the grader blade itself.

Once machine 10 is positioned as desired, an operator may command sideshift movement of coupler assembly 32 in a direction transverse and away from axis A, then execute the necessary maneuvers to engage grabber 36 in slot 48. Once grabber 36 is within slot 48, the operator may command sideshift movement of coupler assembly 32 in an opposite direction, back toward axis A, to bring hook portion 37 into engagement with curved portion 44 of bracket 40a and flange portion 41 into engagement with curved portion 46 of bracket 40a. Engagement of grabber 36 as described will provide the two reaction points mentioned above, and will enable elevating implement 38 without tilting. It should be appreciated, however, that elevating implement 38 is not critical and in some embodiments, or with certain implement types, implement 38 might be simply dragged across the ground.

With grabber 36 engaged in slot 48, the operator may thenceforth command elevating of coupler assembly 32, for example via lift cylinders 80 coupled with drawbar 26, and commence sideshift movement of coupler assembly 32 with implement 38 engaged via grabber 36 back toward axis A. After implement 38 has been moved a desired distance toward axis A, it may be lowered, and grabber 36 engaged with bracket 40b, as described above, and additional lift, sideshift and lower sequences executed until implement 38 is positioned where mating feature 42 is accessible to mounting element 64. Subsequently, mounting element 64 may be actuated to engage with mating feature 42. Where implement 42 comprises a hydraulically actuated implement, for example including a hydraulic motor or cylinder, appropriate hydraulic connections may be made to prepare implement 38 for use. When it is desirable to dispose of implement 38, for example, swapping it with a different implement, the aforementioned steps may be carried out in reverse to incrementally return implement 38 to a storage/disposal location.

The length of implement 38, as well as the range of motion of coupler assembly 32, as defined by its extreme attainable sideshift positions, will tend to affect the number of sideshift motions that are necessary to move implement 38 from a disposal location to a mounting location when retrieving implement 38, or from a mounting location to a disposal location when disposing of implement 38. To this end, grabber 36 might include a plurality of hooking elements, or one or more hooking elements disposed at different locations on coupler assembly 32 than the illustrated positions, depending upon the implements contemplated for use with machine 10. Implement 38 might also be configured differently, and might include features specific to a particular coupler assembly design. Further still, rather than hooking elements, grabber 36 might comprise another type of engagement feature for grabbing an implement. In certain embodiments, grabber 36 might include a hydraulically actuated feature configured to grab or assist in grabbing an implement.

The present disclosure provides substantial improvements over known designs and implement positioning and coupling strategies. Rather than driving over an implement, dragging an implement, excessive backing and turning or some other strategy, the present disclosure will provide a simple, elegant means of retrieving and disposing of implements which are otherwise challenging or impossible to mount to a motor grader. The features and strategy described herein are contemplated to significantly improve motor grader utilization, flexibility and even performance due to the ability to readily apply an implement best suited to a particular task.

The present description is for illustrative purposes only, and should not be construed to narrow the breadth of the present disclosure in any way. Thus, those skilled in the art will appreciate that various modifications might be made to the presently disclosed embodiments without departing from the full and fair scope of the present disclosure. Other aspects, features and advantages will be apparent upon an examination of the attached drawings and appended claims.

What is claimed is:

1. A machine comprising:
a frame having a front set of ground engaging elements and at least one back set of ground engaging elements and a longitudinal axis;
a coupler assembly suspended below said frame and disposed between said front set of ground engaging elements and said at least one back set of ground engaging elements, said coupler assembly being configured for movement transverse to said axis and having an implement mounting element for engaging with a mating feature of an implement; and
an implement grabber mounted to said coupler assembly and configured for grabbing an implement for moving the implement with said coupler assembly to a mounting location relative to said frame at which the implement mounting element can engage with a mating feature of the implement.

2. The machine of claim 1 wherein said coupler assembly is vertically movable and configured via said implement grabber to elevate an implement for moving the implement between the mounting location and a disposal location spaced from said mounting location relative to said longitudinal axis.

3. The machine of claim 2 wherein said coupler assembly includes a front side, a back side, an upper edge and a lower edge, said implement grabber comprising at least one hooking element positioned at the upper edge of said coupler assembly.

4. The machine of claim 3 wherein said implement mounting element is hydraulically actuated, said coupler assembly including at least one hydraulic actuator configured to actuate said mounting element.

5. The machine of claim 4 further comprising an implement configured for grabbing with said implement grabber, said implement including at least one bracket configured to engage with said at least one hooking element and defining a first and a second reaction point with said at least one hooking element.

6. The machine of claim 5 wherein:
said implement includes a center of gravity, the at least one bracket including a first bracket defining first and second reaction points with said at least one hooking element and a second bracket disposed on an opposite side of the center of gravity from said first bracket and also configured to engage with said at least one hooking element; and
said mounting element includes a first pin and a second pin, and the mating feature of said implement includes a first mating feature corresponding to said first pin and a second mating feature corresponding to said second pin, each of said first and second brackets being disposed between said first and second mating features.

7. The machine of claim 5 wherein said at least one hooking element includes a hook extending upwardly from the upper edge of said coupler assembly, and wherein said at least one bracket includes a slot configured to receive said hook and defined at least in part by a first curved portion and a second curved portion of said at least one bracket, said first and second curved portions defining said first and second reaction points, respectively.

8. An implement positioning method for a machine comprising the steps of:
grabbing an implement with an implement grabber mounted on a coupler assembly of the machine, the coupler assembly being suspended below a frame of the machine and disposed between front and back ground engaging elements of the machine;
moving the implement with the coupler assembly transverse to a longitudinal axis of the frame and toward one of a disposal location and a mounting location relative to the frame, after grabbing the implement with the implement grabber;
disengaging the implement from the implement grabber; and
actuating a mounting element of the coupler assembly to engage or disengage with a mating feature of the implement.

9. The method of claim 8 wherein the machine comprises a motor grader machine having a front frame unit and a back frame unit configured to articulate relative to the front frame unit, and wherein the implement is a first implement, the method further comprising a step of decoupling a second implement from the coupler assembly prior to grabbing the first implement with the implement grabber.

10. The method of claim 8 further comprising a step of elevating the implement via the implement grabber prior to the step of moving the implement.

11. The method of claim 10 further comprising a step of retrieving the implement at least in part via the grabbing step and the moving step, including grabbing the implement on a first side of the center of gravity of the implement and moving the implement with the coupler assembly from the disposal location toward the mounting location a first distance, then grabbing the implement on both sides of the center of gravity and moving the implement with the coupler assembly toward the mounting location a second distance.

12. The method of claim 11 wherein the step of actuating the mounting element of the coupler assembly further comprises hydraulically actuating the mounting element subsequent to the step of retrieving the implement.

13. The method of claim 12 further comprising a step of reacting tilting forces of the implement on the coupler assembly during the retrieving step at least in part via first and second reaction points defined by a bracket positioned on the implement and configured to engage with a hooking element of the implement grabber.

14. The method of claim 13 further comprising the steps of:
actuating the mounting element again to disengage the mounting element from the mating feature; and
disposing of the implement, including again grabbing the implement with the implement grabber, and moving the implement toward the disposal location via the coupler assembly.

15. An implement assembly for a machine comprising:
a coupler assembly having a front side, a back side opposite said front side and a width dimension, said coupler being configured for movement relative to a frame of a machine in directions aligned with said width dimension;
a mounting element configured to engage with a mating feature of an implement for mounting an implement at the front side of said coupler assembly; and
an implement grabber mounted to said coupler assembly and configured for grabbing an implement and moving the implement with said coupler assembly to a mounting location at which the mounting element of said coupler assembly can engage with the mating feature of the implement.

16. The implement assembly of claim 15 wherein said coupler assembly includes a body, and wherein said mounting element comprises at least one actuator coupled with movable members disposed at least partially within the body of said coupler assembly.

17. The implement assembly of claim 16 wherein the body of said coupler assembly includes an upper edge and a lower edge, said mounting element being configured to extend from the upper edge of said coupler body, and wherein said implement grabber includes at least one hooking element disposed on the upper edge of said coupler assembly at a location different from a location of said mounting element.

18. The implement assembly of claim 17 further comprising a circle and drawbar assembly configured to suspend said coupler assembly below a frame of a machine, wherein said at least one actuator includes at least one hydraulic actuator configured to actuate said mounting element to mount an implement on said coupler assembly and below the frame of the machine.

19. The implement assembly of claim 16 further comprising an implement including a mating feature configured to mate with said mounting element, said implement being configured to engage with said implement grabber via at least one bracket disposed at a location different from said mating feature.

20. The implement assembly of claim 19 wherein said implement grabber includes at least one hooking element, and wherein the at least one bracket of said implement includes a slot configured to engage with said hooking element, said bracket defining a first reaction point and a second reaction point for reacting tilting forces of said implement on said implement grabber when engaged therewith.
